(19) United States
(12) Patent Application Publication
(10) Pub. No.: US 2010/0235838 A1
(43) Pub. Date: Sep. 16, 2010

(54) METHOD, COMPUTER PROGRAM PRODUCT, AND APPARATUS FOR ENABLING TASK AGGREGATION IN AN ENTERPRISE ENVIRONMENT

(76) Inventors: Jerry Ibrahim, Torrance, CA (US); Jim Schwaller, Wilmington, CA (US); Suresh Ravinarayanan Purisai, Bangalore (IN); Manikandan Rangaswamyraj, Bangalore (IN)

Correspondence Address: HONEYWELL/ALSTON & BIRD;Patent Services, 101 Columbia Road, P.O.Box 2245, Morristown, NJ, 07962, US

(21) Appl. No.: 12/403,180

(22) Filed: Mar. 12, 2009

(51) Int. Cl. G06F 9/46

(52) U.S. Cl. 718/100

(57) ABSTRACT

A method for enabling access task aggregation in an enterprise environment may include receiving indications of a plurality of task related events including at least a first task related event received from a first enterprise application and a second task related event received from a second enterprise application that is different from the first enterprise application, aggregating task related events associated with a particular individual into aggregated information, providing for a display of the aggregated information including indications regarding the task related events associated with the particular individual at a client device associated with the particular individual, enabling receipt of data defining an action taken via the client device in which the action taken defines a response of the particular individual to the aggregated information, and providing information related to the action taken to a corresponding one of the first and second enterprise applications based on to which one of the task related events the action taken corresponds.

### FIELD OF THE INVENTION

Embodiments of the present invention relate generally to task management systems, and more particularly, to a mechanism for enabling aggregation of tasks from different enterprise related systems into a single management mechanism.

### BACKGROUND OF THE INVENTION

Many large companies or enterprises conduct operations in different geographic regions. Additionally, such companies often have distinct programs or business units within either the same or different geographic regions. For example, a company may have separate programs for each type of good or service the company produces. Each of the programs may utilize a number of parts or materials to produce various different products and may use specific resource management applications or tools to manage the people, materials, equipment, products and/or services associated with the various programs. Specialized backend systems or applications may exist for enabling management of the information associated with the various resources involved. These backend systems may be very well suited to the management of the corresponding specific tasks with which they are associated. However, the backend systems may also be very different from each other in terms of their structure, user interface, authentication requirements and other features.

In some cases, managing all the information associated with various different applications or systems that are specific to the information being managed can become cumbersome. For example, managers with responsibilities even within a single business unit may be required to authorize work or expenses or to generate reports or responses using systems or applications specific to the task at hand. Meanwhile, managers with responsibilities that extend over multiple business units may have even more diverse systems and applications with which they must familiarize themselves in order to effectively perform tasks associated with the systems or applications that are specific to the corresponding business units they manage.

An example may be an enterprise with multiple information systems used to implement a business process. The business process may require approvals from various individuals at various different stages. The various individuals may, in some cases, be in different business units or specialties. For example, approval of a contract (or workflow request) may require approval from the business unit providing the good or service contracted for, and also by a representative of the legal department. Thus, business workflow may wait to move to a subsequent step until specific approval decisions are made by the approver personally visiting the relevant website or application to review and approve the contract (or workflow request). As can be seen from the example above, some approvers may not be directly associated with the business unit for which their approval is required and therefore may not be familiar with the workflow management system of each business unit. Moreover, the difficulty of remembering multiple applications that generate approval requests and potential constraints associated with accessing these applications (e.g., via a desktop or laptop computer) may delay approvals in some cases. Approvers in senior leadership positions may also be hampered by travel, meetings and other commitments that may hinder their abilities to access and approve requests.

Accordingly, particularly within the context of enterprise operations, management of the tasks associated with many different backend systems or applications may become an onerous task in and of itself. Thus, it may be desirable to provide a mechanism capable of overcoming the problems described above.

### BRIEF SUMMARY OF THE INVENTION

In order to improve capabilities with respect to task aggregation within an enterprise environment, some embodiments of the present invention may provide a mechanism for enabling easier access to task related information and providing an improved ability to respond to or otherwise manage tasks from a plurality of different sources. Thus, for example, task integration may be performed in relation to tasks originating from a plurality of diverse backend systems or applications and the tasks may be aggregated for distribution to client devices of respective users to which the tasks relate. The client devices may be of various different types including mobile devices in order to make responding to tasks easier for mobile users. Additionally, some embodiments of the present invention may provide for task aggregation while leaving the specific details of workflow management to the backend systems or applications themselves. However, in some embodiments, the task aggregation system described herein may itself provide for workflow management, if desired. Accordingly, information management, and particularly task management may be improved.

In one exemplary embodiment, a method for enabling task aggregation is provided. The method may include receiving indications of a plurality of task related events including at least a first task related event received from a first enterprise application and a second task related event received from a second enterprise application that is different from the first enterprise application, aggregating task related events associated with a particular individual into aggregated information, providing for a display of the aggregated information including indications regarding the task related events associated with the particular individual at a client device associated with the particular individual, enabling receipt of data defining an action taken via the client device in which the action taken defines a response of the particular individual to the aggregated information, and providing information related to the action taken to a corresponding one of the first and second enterprise applications based on to which one of the task related events the action taken corresponds.

In another exemplary embodiment, a computer program product for enabling task aggregation is provided. The computer program product comprising at least one computer-readable storage medium having computer-executable program code instructions stored therein. The computer-executable program code instructions may include program code instructions for receiving indications of a plurality of task related events including at least a first task related event received from a first enterprise application and a second task related event received from a second enterprise application that is different from the first enterprise application, aggregating task related events associated with a particular individual into aggregated information, providing for a display of the aggregated information including indications regarding the task related events associated with the particular individual at a client device associated with the particular individual, enabling receipt of data defining an action taken via the client device in which the action taken defines a response of the particular individual to the aggregated information, and providing information related to the action taken to a corresponding one of the first and second enterprise applications based on to which one of the task related events the action taken corresponds.

In another exemplary embodiment, an apparatus for enabling task aggregation is provided. The apparatus may include an integrator and an aggregator. The integrator may be configured to receive indications of a plurality of task related events including at least a first task related event received from a first enterprise application and a second task related event received from a second enterprise application that is different from the first enterprise application. The aggregator may be configured to aggregate task related events associated with a particular individual into aggregated information, provide for a display of the aggregated information including indications regarding the task related events associated with the particular individual at a client device associated with the particular individual, and enable receipt of data defining an action taken via the client device, the action taken defining a response of the particular individual to the aggregated information. The integrator may be further configured to provide information related to the action taken to a corresponding one of the first and second enterprise applications based on to which one of the task related events the action taken corresponds.

Embodiments of the present invention may therefore provide a mechanism for enabling relatively easy access to task management related enterprise information. As a result, productivity of the enterprise may be increased.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a basic block diagram illustrating a system for enabling task management according to an exemplary embodiment of the present invention;

FIG. 2 is a basic block diagram of an apparatus for enabling task management according to an exemplary embodiment of the present invention;

FIG. 3 shows an example of a display at a client device indicating various task related events for a particular user according to an exemplary embodiment of the present invention;

FIG. 4 illustrates an example of a response template that may be provided in response to selection of a particular task related event according to exemplary embodiments of the present invention; and

FIG. 5 is a flowchart according to an exemplary method of enabling task management according to one embodiment of the present invention.

### DETAILED DESCRIPTION OF THE INVENTION

Embodiments of the present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like reference numerals refer to like elements throughout.

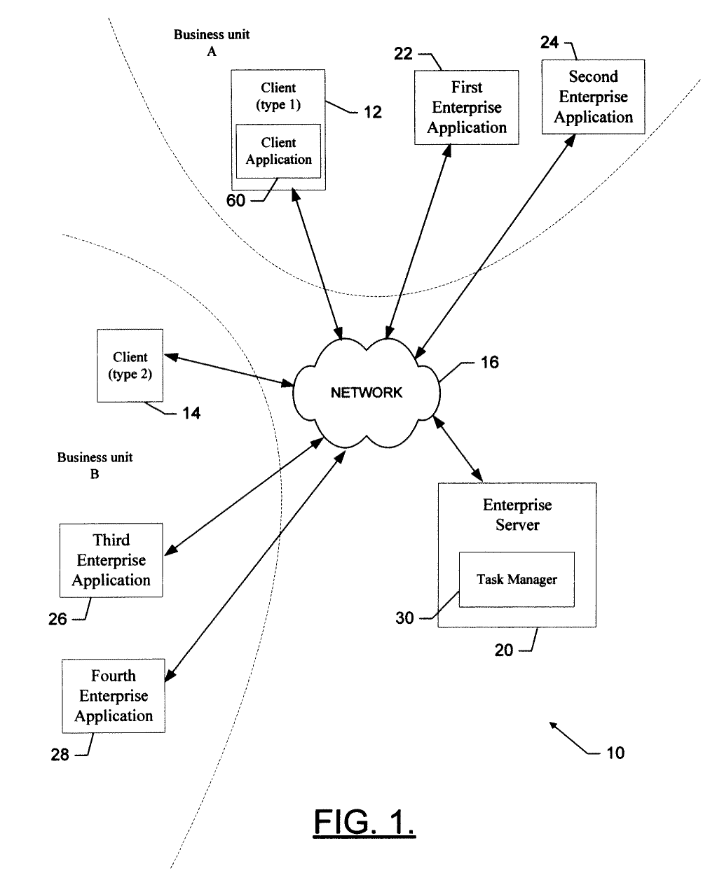

FIG. 1 is a basic block diagram illustrating a system 10 for enabling task aggregation in an enterprise environment according to an exemplary embodiment. It should be noted that while FIG. 1 will be described mainly in the context of approval request related information, embodiments of the present invention are not limited to applications related only to approval requests, but are instead more broadly applicable to managing tasks in an enterprise environment. Furthermore, although embodiments of the present invention provide improvements that may be particularly useful in the context of a business enterprise environment, embodiments may also be employed in smaller operations that are not necessarily enterprises, but operate with numerous specific applications or backend systems for managing tasks related to specific corresponding operations.

As shown in FIG. 1, the system 10 may include one or more clients that may, in some cases, be associated with respective particular individuals in corresponding business units of an enterprise. For example, a first client (e.g., client 12) may be associated with a first business unit (e.g., business unit A) and a second client (e.g., client 14) may be associated with a second business unit (e.g., business unit B). However, some clients may not be associated with any particular business unit, but may instead be associated with an individual that is part of, interfaces with or manages several different business units. The business units may be geographically collocated or remote from each other and may be distinct development programs, departments, businesses within a conglomerate, and/or the like. In some cases, a plurality of clients may be included in the system 10 from each business unit and/or more than just the two business units shown may also be included in the system 10. Many other types of information may also be managed by embodiments of the present invention, including but not limited to those mentioned herein. The clients 12 and 14 may be personal computers, laptop computers, fixed communication terminals, mobile communication terminals (e.g., cellular telephones, personal digital assistants (PDAs), mobile email devices, and/or the like), or other communication devices that are capable of communication with a network 16. In an exemplary embodiment, the clients 12 and 14 may each be the same type of device or may be different types of devices as shown in FIG. 1.

The network 16 may be a data network, such as a local area network (LAN), a metropolitan area network (MAN), a wide area network (WAN) (e.g., the Internet), and/or the like, which may couple the clients 12 and 14 to devices such as processing elements (e.g., personal computers, server computers or the like) or databases. Communication between the network 16, the clients 12 and 14 and the devices or databases (e.g., servers) to which the clients 12 and 14 are coupled may be accomplished by either wireline or wireless communication mechanisms and corresponding protocols.

In an exemplary embodiment, one of the devices to which the clients 12 and 14 may be coupled via the network 16 may include an enterprise server 20. The enterprise server 20 may include hardware and/or software for configuring the enterprise server 20 to perform various functions. As such, for example, the enterprise server may include processing logic and memory enabling the enterprise server 20 to access and/or execute stored computer readable instructions for performing various functions. In an exemplary embodiment, one function that may be provided by the enterprise server 20 may be the provision of task related information to the clients 12 and 14. Additionally or alternatively, the enterprise server 20 may be configured to enable the clients 12 and 14 to provide task related responses to various different backend systems or applications that may be specific to particular business units or segments of business units. The various different backend systems or applications may be collectively referred to as enterprise applications (e.g., first enterprise application 22, second enterprise application 24, third enterprise application 26 and fourth enterprise application 28). Each enterprise application may be associated with a particular business unit (e.g., the first and second enterprise applications 22 and 24 are associated with business unit A and the third and fourth enterprise applications 26 and 28 are associated with business unit B) and each business unit may have one or more different enterprise applications associated therewith. However, some business units may have no enterprise applications associated therewith. The backend systems or applications corresponding to each enterprise application may include hardware and/or software specific solutions aimed at providing specific functionality related to workflow or information management. In general, the backend systems or applications may each provide for specific, and in many cases different, task management services corresponding to their respective business units.

In some embodiments, the enterprise server 20 may store and/or execute instructions via a processor, controller or other processing element. As such, the enterprise server 20 may include memory for storing such instructions. In some cases, the enterprise server 20 may host applications providing services on an enterprise-wide basis. As such, for example, the enterprise server 20 may be a server, server bank or other computer or group of computers configured to provide one or more services (e.g., task management services) for the entire enterprise via the network 16. Although the enterprise server 20 is shown as a single entity in FIG. 1, it should be appreciated that the enterprise server 20 may represent a plurality of entities (e.g., as in the case of a bank of servers or computers) that may be distributed in terms of location. Moreover, some portions of the enterprise server 20 may be distributed, while other portions are centralized in a particular location or device.

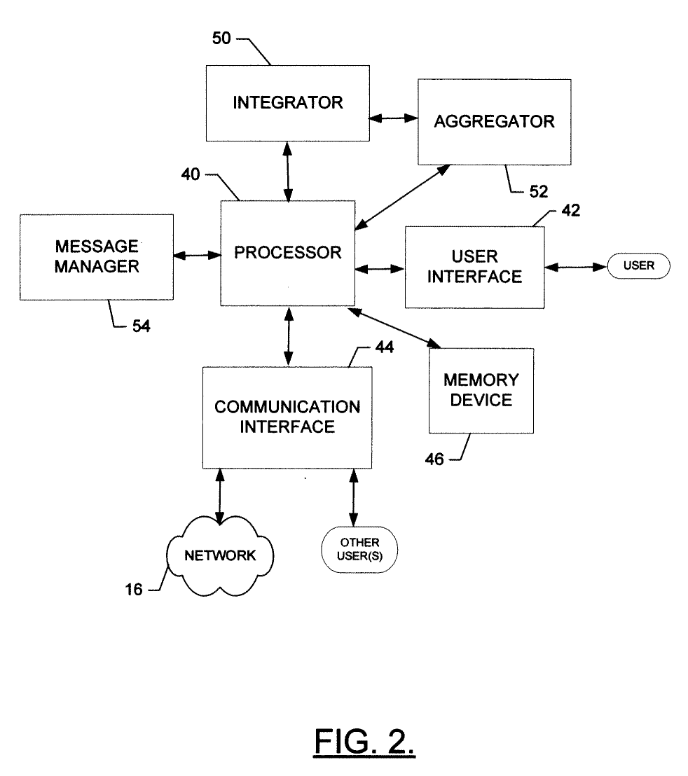

In an exemplary embodiment, the enterprise server 20 may include, host or otherwise be in communication with a task manager 30. The task manager 30 may be any means such as a device or circuitry embodied in hardware, software or a combination of hardware and software that is configured to perform the corresponding functions of the task manager 30 as described herein. FIG. 2 illustrates one example construction of the task manager 30 according to an exemplary embodiment.

An exemplary embodiment of the invention will now be described with reference to FIG. 2, in which certain elements of an apparatus for enabling task aggregation according to an exemplary embodiment are displayed. The apparatus of FIG. 2 (e.g., the task manager 30) may be employed, for example, on a variety of other devices (such as, for example, a network device, server, proxy, or the like (e.g., the enterprise server 20 of FIG. 1)). Alternatively, embodiments may be employed on a combination of devices. Accordingly, some embodiments of the present invention may be embodied wholly at a single device (e.g., the enterprise server 20) or by devices in a distributed fashion. Furthermore, it should be noted that the devices or elements described below may not be mandatory and thus some may be omitted in certain embodiments.

Referring now to FIG. 2, an apparatus for enabling access to enterprise information is provided. The apparatus may include or otherwise be in communication with a processor 40, a user interface 42, a communication interface 44 and a memory device 46. The memory device 46 may include, for example, volatile and/or non-volatile memory. The memory device 46 may be configured to store information, data, applications, instructions or the like for enabling the apparatus to carry out various functions in accordance with exemplary embodiments of the present invention. For example, the memory device 46 could be configured to buffer input data for processing by the processor 40. Additionally or alternatively, the memory device 46 could be configured to store instructions for execution by the processor 40. As yet another alternative, the memory device 46 may be one of a plurality of databases that store information.

The processor 40 may be embodied in a number of different ways. For example, the processor 40 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 40 may be configured to execute instructions stored in the memory device 46 or otherwise accessible to the processor 40. As such, whether configured by hardware or software methods, or by a combination thereof, the processor 40 may represent an entity capable of performing operations according to embodiments of the present invention while configured accordingly. Thus, for example, when the processor 40 is embodied as an ASIC, FPGA or the like, the processor 40 may be specifically configured hardware for conducting the operations described herein. Alternatively, as another example, when the processor 40 is embodied as an executor of software instructions, the instructions may specifically configure the processor 40, which may otherwise be a general purpose processing element if not for the specific configuration provided by the instructions, to perform the algorithms and operations described herein. However, in some cases, the processor 40 may be a processor of a specific device (e.g., the enterprise server 20) adapted for employing embodiments of the present invention by further configuration of the processor 40 by instructions for performing the algorithms and operations described herein.

Meanwhile, the communication interface 44 may be any means such as a device or circuitry embodied in either hardware, software, or a combination of hardware and software that is configured to receive and/or transmit data from/to a network (e.g., the network 16) and/or any other device or module in communication with the apparatus. In this regard, the communication interface 44 may include, for example, an antenna and supporting hardware and/or software for enabling communications with a wireless communication network and/or a communication modem and/or other hardware/software for supporting communication via cable, digital subscriber line (DSL), universal serial bus (USB) or other wireline based communication mechanisms.

The user interface 42 may be in communication with the processor 40 to receive an indication of a user input at the user interface 42 and/or to provide an audible, visual, mechanical or other output to the user. As such, the user interface 42 may include, for example, a keyboard, a mouse, a joystick, a touch screen display, a display, a microphone, a speaker, or other input/output mechanisms. In an exemplary embodiment in which the apparatus is embodied as a server or some other network device, the user interface 42 may be limited, or even eliminated. However, in some embodiments in which the apparatus is embodied as a network device or server, the user interface 42 may include, among other devices or elements, any or all of a speaker, a microphone, a display, and a keyboard or the like of a terminal in communication with the network device or server.

In an exemplary embodiment, the processor 40 may be embodied as, include or otherwise control an integrator 50, an aggregator 52, and a message manager 54. The integrator 50, the aggregator 52, and the message manager 54 may each be any means such as a device or circuitry embodied in hardware, software or a combination of hardware and software that is configured to perform the corresponding functions of the integrator 50, the aggregator 52, and the message manager 54, respectively, as described below. In some embodiments, an instance of each of the integrator 50, the aggregator 52, and the message manager 54 may be included at the enterprise server 20. However, in other embodiments one or more of the integrator 50, the aggregator 52, and the message manager 54 may be instantiated at the enterprise server 20 while others of the integrator 50, the aggregator 52, and the message manager 54 are instantiated (perhaps in distributed fashion) at one or more of the business units (e.g., in distributed servers or other devices in communication with the network 16).

The integrator 50 may be configured to receive indications of task related events from various enterprise applications and provide an integration point of the received data for aggregating the task related events on a user by user basis. Since each of the various enterprise applications may have different formats, protocols, interface or response options, and other distinct characteristics, the integrator 50 may be customized for interfacing with each of the enterprise applications supported. As such, for example, the integrator 50 may comprise a collection of modules in which each module includes information enabling the integrator 50 to interface with a corresponding backend system or application of a particular enterprise application. In this regard, for example, if the first enterprise application 22 is a backend system related to project management of business unit A and the second enterprise application 24 is a backend system related to budget management for business unit A, the integrator 50 may include a module defining interface parameters to enable the task manager 30 to communicate with the first enterprise application 22 and a separate module defining interface parameters to enable the task manager 30 to communicate with the second enterprise application 24. As indicated above, the integrator 50 may be distributed. Thus, in some cases, the modules for enabling communication with respective enterprise applications may be located remotely from the aggregator 52 (e.g., within each respective business unit or in some other distributed fashion). However, in some embodiments, the enterprise server 20 may provide a central location for all or at least a plurality of modules with no or only some modules being remotely located.

The integrator 50 provides a customized device for enabling the provision of task related events or information to the aggregator 52 and also provides a customized device for enabling the receipt of a data defining an action taken in response to the task related event by a particular individual. In other words, the integrator 50 provides a customized integration point enabling communication with various diverse backend systems or applications to receive task related event information from each system or application and to provide each system or application with an indication of a response from the corresponding individual to whom the respective task related event information applied. Given that the integrator 50 includes communication modules customized for each enterprise application to which the integrator 50 is configured to communicate, the integrator 50 may act as a scalable and upgradable interpreter between backend systems or applications and the aggregator 52.

The task related events may be tasks of any kind ranging from simple reminders or alerts to more complicated forms that may be filled out by the receiver of the task related event (e.g., the person being tasked). As an example, the task related event may be a project, invoice, repair request, work request, parts requisition, evaluation request, request for a report, reminder, alert, or any of numerous other tasks that may request the recipient to take an action. In some cases, the task related event may further define a time period within which a response is desired or required. The task related event may also define acceptable responses or at least a format or options for response. For example, a repair request may have three possible responses such as “approve”, “reject” and “hold”, one of which must be provided within twenty four hours (or some other predetermined time) of receipt.

The integrator 50 may be configured to receive an indication of the task related event and recognize, based on the indication, parameters (e.g., intended recipient, possible responses, time limits, etc.) associated with the task related event that may influence the information ultimately provided to the task recipient (e.g., via client 12 or client 14). In this regard, for example, the integrator 50 may be configured to parse messages received from particular enterprise applications (or pull specific information from the particular enterprise applications) and, based on rules defining message formats for respective particular enterprise applications, extract information defining possible responses and the due date/time for response from the messages received (or information pulled). Alternatively, the integrator 50 may be aware of specific rules or parameters (e.g., intended recipient address, possible responses, time limits for response, etc.) that may apply universally to particular message types received from a certain enterprise application. In some cases, the integrator 50 may further handle credentialing or authentication services in order to ensure that the integrator is authorized to obtain task related information from relevant sources.

Accordingly, the integrator 50 may integrate all indications of task related events (regardless of the intended recipient of the task related events) from each of the various different enterprise applications and communicate data regarding the task related events to the aggregator 52. The information provided to the aggregator 52 may include (if applicable), for example, an identification of the intended recipient of the task related event (e.g., by email address, phone number or other identity), an identification of the task related event (e.g., a form, a message, a response interface, etc.), possible responses to the task related event, a due date and/or time for response, and other information.

The aggregator 52 may be configured to aggregate task related events by recipient and provide the task related events for a particular recipient to the client device associated with the particular recipient based on the information provided by the integrator 50. The aggregated tasks for each recipient may then be provided to the corresponding recipients. In an exemplary embodiment, the aggregator 52 may use messaging via any suitable protocol or messaging service in order to communicate with the client devices (e.g., client 12 and/or client 14) of the corresponding recipients of the task related events. As such, for example, the aggregator 52 may employ the message manager 54 to send formatted messages and receive responses from the recipients of the task related events.

In an exemplary embodiment, the aggregator 52 may use the messages provided to the client devices in order to provide for a display of aggregated information including indications regarding task related events to a client device associated with the particular individual intended for receipt of the task related events. However, the aggregator 52 need not aggregate multiple messages for any particular individual prior to providing the particular individual with any single task related event. Thus, although the aggregator 52 is configured to aggregate multiple tasks for a particular user, the aggregator 52 may still operate to provide notice to the particular individual of a single task so long as the aggregator 52 is further capable of later providing (e.g., via messaging) for updating the display of the client device of the particular individual in response to receipt of additional task related events for the particular individual. In some embodiments, the aggregator 52 may be further configured to handle authentication and/or authorization of users in order to grant access for the user to aggregated sets of tasks or enable the user to take actions with respect to a particular task.

In an exemplary embodiment, the message manager 54 may provide messages to the client device of a particular individual (e.g., client 12) in response to receipt of indications of a task related event from an enterprise application in which the particular individual is identified as a recipient of the task related event (e.g., identified by the integrator 50 as the party being tasked). The message manager 54 may provide such messages in response to direction from the aggregator 52. The messages provided by the message manager 54 may direct provision of a display of information related to the task related event at the client device. In an exemplary embodiment, each client device may execute a client application 60 configured to operate in conjunction with the task manager 30. For example, the client application 60 may be configured to receive standard messages from the message manager 54 and extract formatted information from the standard messages in order to give the particular individual associated with the task related event (e.g., the person being tasked) options for response, an indication of the deadline for response, information defining the task, and/or the like. Notably, although only one client application 60 is shown in FIG. 1 as an example, each client may include a respective instance of the client application 60 in some cases.

The client application 60 may include stored instructions within a memory device of the client device (e.g., client 12 or client 14) and may be executed by a processor of the client device. The client application 60 may be configured to receive and communicate indications of a user action taken in response to the task related event. For example, after displaying a task related event and various options for response, the user may select one option for response (e.g., approval of a work request). Indications of the selected response may then be communicated back to the aggregator 52 by the client application 60 via the message manager 54. The aggregator 52 may then update a listing of task related events for the particular individual from whom the response was received and also generate messaging to communicate data defining the action taken in response to the task related event to the corresponding enterprise application associated with the task related event via the integrator 50. In other words, the aggregator 52 may inform the corresponding enterprise application of the response via the customized communication capability of the integrator 50 with respect to communicating with the corresponding enterprise application. In some embodiments, the listing of task related events (e.g., including a full or partial task list) may be stored in the memory device 46 or at some other location accessible to the processor 40 and/or the aggregator 52.

In an exemplary embodiment, the aggregator 52 may maintain a listing of task related events for each individual and may update the listing as appropriate based on new task related events received and status updates on task related events based on responses received via the message manager 54. Thus, for example, the aggregator 52 may provide for display of the listing or a portion of the listing via the client application 60 by synchronizing with the client application 60 at random or predetermined intervals. As an alternative, the aggregator 52 may simply push messages defining task related events to corresponding clients without maintaining a listing of task related events. In such an embodiment, the user of each client device may define (e.g., via preferences or user settings associated with the client application 60) the style of presentation of the task related events received for the corresponding client device. As such, the user may indicate a preference for a list format presentation of task related events. In some cases, for example, the user may define that only task related events that have not yet been responded to be shown, while tasks that have been responded to are expunged or stored in a separate folder. The user may also define ordering criteria (e.g., by date received, due date, priority, business unit or backend system, etc.) for presentation of the task related events at the client device.

The messages provided from the aggregator 52 via the message manager 54 may be provided in some cases as alerts. Moreover, in some cases, the alerts may be SMS messages or email messages formatted by the message manager 54 based on information provided by the aggregator 52 for delivery to the client device of the intended recipient of the corresponding task related event. Accordingly, for example, embodiments of the present invention may broker tasks for individuals from diverse backend systems and deliver the tasks to individuals being tasked via email or some other communication mechanism that is suitable for mobile users. As such, embodiments of the present invention may be integrated with the mobile user's email service such that the task related events are communicated to the mobile user as an email alert. However, in alternative examples, the alerts may be provided in a web based environment. In some examples, the task related events may be received and/or presented in connection with an application specific to the management of tasks for the user (e.g., the client application 60). In such embodiments, the user may have a locally executable application (e.g., the client application 60) at the client device of the user configured to present a display of task related event information based on messages received from the aggregator 52 via the message manager 54. Thus, for example, messages from the aggregator 52 may populate a web page with task related events associated with a particular individual. The particular individual may then access the web page (in some cases subject to authorization and/or authentication as described above) from any fixed or mobile terminal capable of running the client application 60.

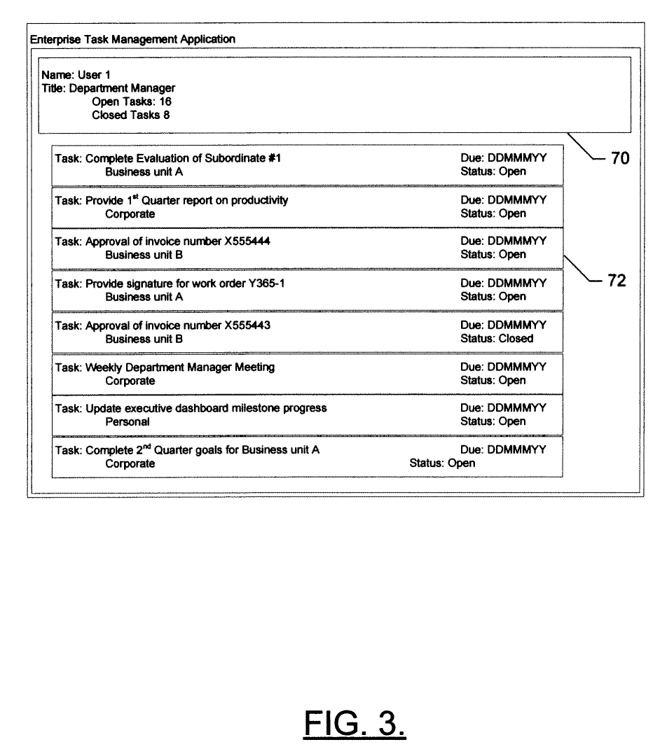

FIG. 3 shows an example of a display at a client device indicating various task related events for a particular user. It should be noted, however, that the example of FIG. 3 merely shows one way in which task related events may be presented and numerous other ways are also possible. As shown in FIG. 3, a banner 70 may be displayed providing information that is not specific to any particular task related event. In this regard, for example, the banner 70 may include information such as an identification of the particular user and/or the title or business unit of the particular user. In some cases, the banner 70 may also provide information identifying the number of open task related events (e.g., tasks that are awaiting a response) and/or a number of closed task related events (e.g., tasks for which a response has been provided). In an exemplary embodiment, a listing of task related events may be provided. Task 72 is one example of task related events that may be displayed for the particular user. Each task related event may have various types of information associated therewith. In the example of FIG. 3, each task related event includes a brief description of the task associated therewith, the due date for response, the business unit associated with the task or the entity assigning the task, and a status indicator. However, more, different or even less information could be provided in alternative embodiments. The task related events may be user selectable in order to enable access to more detailed information about the selected task related event and/or in order to enable the provision of a response to the task related event.

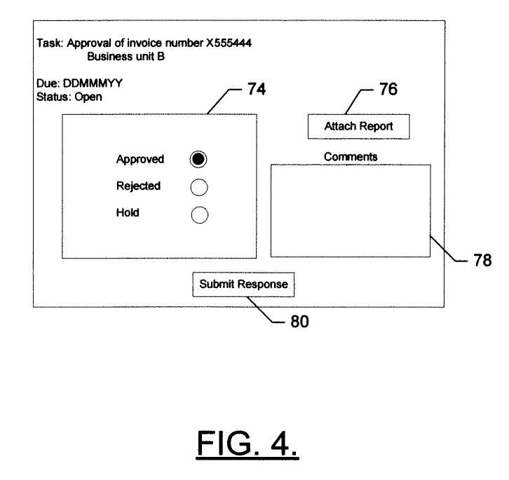

FIG. 4 illustrates an example of a response template that may be provided in response to selection of a particular task related event (e.g., task 72). As shown in FIG. 4, the response template may include a response selection box 74. The response selection box 74 may include options for response as defined by the integrator 50 based on the options communicated thereto by the enterprise application from which the task related event originated. In some cases, the response template may also include an option for attachment of documents (e.g., attach report button 76) so that a separate report or other document may be provided with the response. In an exemplary embodiment, the response template may further include a comment box 78 to enable the user to provide comments that may be reported back to the enterprise application from which the task related event originated. The response may be submitted by selection of button 80. After submission of the response, the status of the task related event may transition to “closed”.

Embodiments of the present invention may provide improvement over a typical task management system that merely links the user to backend systems or applications to which a particular task corresponds in that the tasked individual need not interact directly with the backend systems or applications. Thus, the tasked individual need not maintain familiarity with nuances of different enterprise applications. Instead, the nuances of each enterprise application are accounted for by the integrator 50, so that the integrator 50 provides customized interface with each enterprise applications to receive task related events from the different enterprise applications for provision to the tasked individual and thereafter receiving a response from the tasked individual and passing the response back to the respective enterprise application. Accordingly, specific workflow issues may be left to the backend systems and applications that are tailored specifically to provide workflow management for their respective regimes. However, at the tasked individuals end, interaction with multiple different tasks from multiple different systems that may have different interface mechanisms is provided in a relatively seamless manner. It should also be noted that in some embodiments, the task aggregation system described herein may itself provide for workflow management, if desired.

Thus, for example, embodiments of the present invention may provide a centralized system or solution for receiving tasks, which may include notifications (with or without actions), from different types of participating applications and brokering the received tasks to different types of clients. Due to the fact that the client never needs to directly interface with the participating applications, the client may be freed from being tied to fixed terminals or laptop computers. As such, users may interface with tasks from many different sources in one forum that enables users to provide responses that can be translated back to the participating applications without requiring the users to visit the participating applications themselves. Embodiments of the present invention therefore may provide channels for use by the user to employ for receiving messages indicative of aggregated tasks from across the business enterprise without visiting different participating applications themselves. The user may also then provide responses to the aggregated tasks via the channels.

The items (e.g., task related events) that are consolidated or aggregated may be signature requirements (for which digital signatures may be provided) or other approval requests, but may also be general alters of various kinds for which the user is expected to take action. Approval request items may or may not require one or more user inputs to process user approval actions. In order to aggregate or consolidate approval requests or other alerts for users, the items can be pushed to the centralized system by the participating application (e.g., the enterprise applications may push task related events to the task manager 30) or the items may be pulled from the participating application (e.g., an event listener or a proxy tool may recognize a task related event at the enterprise application and pull data from the enterprise application to generate an indication of the event for use by the task manager 30 as described herein). As indicated above, a consolidated list of alerts, requests or other task related events may be provided to multiple clients that may be associated with various different users (e.g., mobile phones, PDAs, portal applications, document management services, email services, web sites, widgets, gadgets, and/or the like). As such, the same user may have many different ways of accessing task management information dependent upon which device the user currently has available or prefers to utilize. The centralized system may further be enabled to accept approvals or other response actions that may or may not include additional information (e.g., attached documents or comments) from the channels the user employs to take action. As such, the centralized system may synchronously or asynchronously pass the user action along to the participating application. In some cases, a response from the participating application may also be passed back to the user as confirmation.

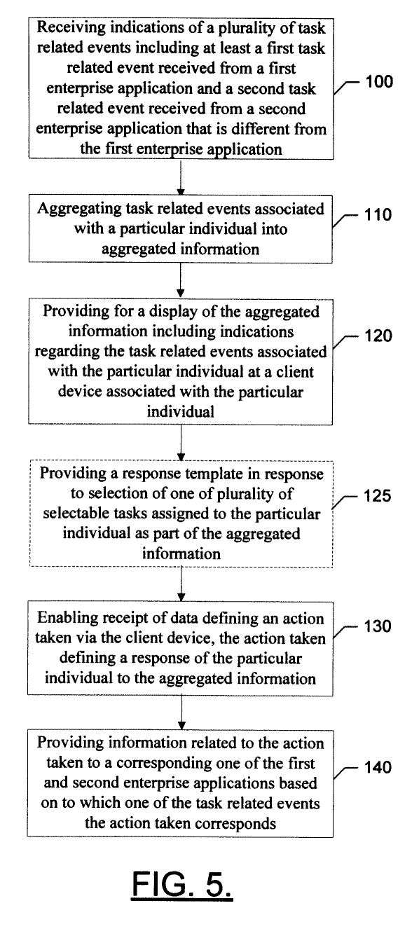

FIG. 5 is a flowchart of a system, method and program product according to exemplary embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a computing device, and executed by a processor of the computing device. As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method of enabling task aggregation, as shown in FIG. 5, includes receiving indications of a plurality of task related events including at least a first task related event received from a first enterprise application and a second task related event received from a second enterprise application that is different from the first enterprise application at operation 100 and aggregating task related events associated with a particular individual into aggregated information at operation 110. The method may further include providing for a display of the aggregated information including indications regarding the task related events associated with the particular individual at a client device associated with the particular individual at operation 120 and enabling receipt of data defining an action taken via the client device in which the action taken defines a response of the particular individual to the aggregated information at operation 130. The method may further include providing information related to the action taken to a corresponding one of the first and second enterprise applications based on to which one of the task related events the action taken corresponds at operation 140. Accordingly, task related event brokering may be provided without execution of the enterprise applications associated with each task related event.

In some embodiments, additional optional operations may also be performed. An example of an optional operation is shown in FIG. 5 in dashed lines. In this regard, in a situation in which providing for the display of the aggregated information includes providing for a display of a plurality of selectable tasks assigned to the particular individual, the method may further include providing a response template in response to selection of one of the selectable tasks at operation 125. The response template may define possible responses for the selected task in which the possible responses being determined based on information provided by a respective one of the first and second enterprise applications.

In some embodiments, certain ones of the operations above may be modified or further amplified as described below. It should be appreciated that each of the modifications or amplifications below may be included with the operations above either alone or in combination with any others among the features described herein. In this regard, for example, enabling receipt of the data defining the action taken may include receiving an indication of the response from the particular individual provided in a response template generated based on rules associated with the one of the first enterprise application or the second enterprise application that provided the corresponding task related event. In some cases, providing for display may include sending a message to the client device defining information for display in relation to a task related event and providing information may include sending a response message to a backend system or application corresponding a respective one of the first enterprise application or the second enterprise application associated with which the action taken corresponds. In some cases, providing for display may include providing one of a web page or a message alert application providing a listing of the task related events and/or providing messages defining display parameters for displaying the task related events at a mobile device.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
receiving indications of a plurality of task related events including at least a first task related event received from a first enterprise application and a second task related event received from a second enterprise application that is different from the first enterprise application;
aggregating task related events associated with a particular individual into aggregated information;
providing for a display of the aggregated information including indications regarding the task related events associated with the particular individual at a client device associated with the particular individual;
enabling receipt of data defining an action taken via the client device, the action taken defining a response of the particular individual to the aggregated information; and
providing information related to the action taken to a corresponding one of the first and second enterprise applications based on to which one of the task related events the action taken corresponds.

2. The method of claim 1, wherein providing for the display of the aggregated information comprises providing for a display of a plurality of selectable tasks assigned to the particular individual.

3. The method of claim 2, further comprising providing a response template in response to selection of one of the selectable tasks, the response template defining possible responses for the selected task, the possible responses being determined based on information provided by a respective one of the first and second enterprise applications.

4. The method of claim 1, wherein enabling receipt of the data defining the action taken comprises receiving an indication of the response from the particular individual provided in a response template generated based on rules associated with the one of the first enterprise application or the second enterprise application that provided the corresponding task related event.

5. The method of claim 1, wherein providing for display comprises sending a message to the client device defining information for display in relation to a task related event and wherein providing information comprises sending a response message to a backend system or application corresponding a respective one of the first enterprise application or the second enterprise application associated with which the action taken corresponds.

6. The method of claim 1, wherein providing for display comprises providing one of a web page or a message alert application providing a listing of the task related events.

7. The method of claim 1, wherein providing for display comprises providing messages defining display parameters for displaying the task related events at a mobile device.

8. A computer program product comprising at least one computer-readable storage medium having computer-executable program code instructions stored therein, the computer-executable program code instructions comprising:
program code instructions for receiving indications of a plurality of task related events including at least a first task related event received from a first enterprise application and a second task related event received from a second enterprise application that is different from the first enterprise application;
program code instructions for aggregating task related events associated with a particular individual into aggregated information;
program code instructions for providing for a display of the aggregated information including indications regarding the task related events associated with the particular individual at a client device associated with the particular individual;
program code instructions for enabling receipt of data defining an action taken via the client device, the action taken defining a response of the particular individual to the aggregated information; and
program code instructions for providing information related to the action taken to a corresponding one of the first and second enterprise applications based on to which one of the task related events the action taken corresponds.

9. The computer program product of claim 8, wherein program code instructions for providing for the display of the aggregated information include instructions for providing for a display of a plurality of selectable tasks assigned to the particular individual.

10. The computer program product of claim 9, further comprising program code instructions for providing a response template in response to selection of one of the selectable tasks, the response template defining possible responses for the selected task, the possible responses being determined based on information provided by a respective one of the first and second enterprise applications.

11. The computer program product of claim 8, wherein program code instructions for enabling receipt of the data defining the action taken include instructions for receiving an indication of the response from the particular individual provided in a response template generated based on rules associated with the one of the first enterprise application or the second enterprise application that provided the corresponding task related event.

12. The computer program product of claim 8, wherein program code instructions for providing for display include instructions for sending a message to the client device defining information for display in relation to a task related event and wherein program code instructions for providing information include instructions for sending a response message to a backend system or application corresponding a respective one of the first enterprise application or the second enterprise application associated with which the action taken corresponds.

13. The computer program product of claim 8, wherein program code instructions for providing for display include instructions for providing one of a web page or a message alert application providing a listing of the task related events.

14. An apparatus comprising:
an integrator configured to receive indications of a plurality of task related events including at least a first task related event received from a first enterprise application and a second task related event received from a second enterprise application that is different from the first enterprise application;
an aggregator configured to:
aggregate task related events associated with a particular individual into aggregated information,
provide for a display of the aggregated information including indications regarding the task related events associated with the particular individual at a client device associated with the particular individual, and
enable receipt of data defining an action taken via the client device, the action taken defining a response of the particular individual to the aggregated information,
wherein the integrator is further configured to provide information related to the action taken to a corresponding one of the first and second enterprise applications based on to which one of the task related events the action taken corresponds.

15. The apparatus of claim 14, wherein the aggregator is configured to provide for the display of the aggregated information by providing for a display of a plurality of selectable tasks assigned to the particular individual.

16. The apparatus of claim 15, wherein the aggregator is further configured to generate messages for providing a response template in response to selection of one of the selectable tasks, the response template defining possible responses for the selected task, the possible responses being determined based on information provided by a respective one of the first and second enterprise applications.

17. The apparatus of claim 14, wherein the aggregator is configured to enable receipt of the data defining the action taken by receiving an indication of the response from the particular individual provided in a response template generated based on rules associated with the one of the first enterprise application or the second enterprise application that provided the corresponding task related event.

18. The apparatus of claim 14, wherein the aggregator is configured to provide for display by sending a message to the client device defining information for display in relation to a task related event and wherein providing information comprises sending a response message to a backend system or application corresponding a respective one of the first enterprise application or the second enterprise application associated with which the action taken corresponds.

19. The apparatus of claim 14, wherein the aggregator is configured to provide for display by providing one of a web page or a message alert application providing a listing of the task related events.

20. The apparatus of claim 14, wherein the aggregator is configured to provide for display by providing messages defining display parameters for displaying the task related events at a mobile device.
